(19) United States
(12) Patent Application Publication
(10) Pub. No.: US 2015/0184938 A1
(43) Pub. Date: Jul. 2, 2015

(54) RESIN CURING DEVICE AND METHOD OF CURING PHOTO-CURING RESIN

(71) Applicant: Hajime Tanihara, Osaka (JP)

(72) Inventor: Hajime Tanihara, Osaka (JP)

(73) Assignee: PANASONIC INTELLECTUAL PROPERTY MANAGEMENT CO., LTD., Osaka (JP)

(21) Appl. No.: 14/127,635

(22) PCT Filed: Jul. 19, 2013
(86) PCT No.: PCT/JP2013/004412

§ 371 Date: Dec. 19, 2013

(30) Foreign Application Priority Data
Aug. 24, 2012 (JP) 2012-184738

(51) Int. Cl. F26B 23/04

(52) U.S. Cl. CPC F26B 23/04

(57) ABSTRACT

A resin curing device for curing photo-curing resin applied to a nail. The resin curing device includes a light source and a controller controlling light irradiation to photo-curing resin. The controller changes an irradiated light quantity in an irradiation period to adjust a gloss level when photo-curing resin is cured. Accordingly, the resin curing device can adjust the gloss level of photo-curing resin when it is cured.

This application is a U.S. National Phase Application of PCT International Application PCT/JP2013/004412.

### TECHNICAL FIELD

The present invention relates to resin curing devices for curing photo-curing resin by exposing photo-curing resin applied to fingernails and toenails to light, and methods of curing photo-curing resin.

### BACKGROUND ART

To decorate fingernails and toenails, a fake nail, such as a nail chip and sculptured nail, has been generally bonded to a natural nail.

Fake nails include a gel nail that is to form an artificial nail by using gel mainly composed of urethane acrylic resin. Gel is one type of photo-curing resin, and cures when exposed to a light in a specific ultraviolet range to form an artificial nail.

For gel nails, a resin curing device for emitting a light in an ultraviolet range for curing the gel has been proposed (e.g., PTL1 and PTL2.)

In general, a conventional resin curing device typically uses a UV lamp, such as a mercury lamp and fluorescent lamp, or ultraviolet ray light-emitting diode (hereafter referred to as “UV-LED”).

A xenon flash lamp is also disclosed as one of light sources used for curing photo-curing resin (e.g., PTL3).

For gel nails, gloss of cured gel (photo-curing resin) is also one of important aesthetic elements to produce decorative effect. In general, high-gloss gel (photo-curing resin) is preferred. However, high-gloss gel is not always preferred. Depending on design, low-gloss, i.e., mat gel (photo-curing resin), is preferred.

Conventional resin curing devices are not capable of adjusting a gloss level on curing photo-curing resin, according to user's preference.

### CITATION LIST

### Patent Literature

PTL1 Japanese Utility Model No. 3151698

PTL2 Japanese Patent Unexamined Publication No. 2011-98073

PTL 3 Japanese Patent Unexamined Publication No. 2011-76825

### SUMMARY OF THE INVENTION

To prevent the above disadvantage, the present invention offers a resin curing device for curing photo-curing resin applied to a nail. The resin curing device includes a light source and a controller for controlling irradiated light to photo-curing resin. The controller changes the irradiated light quantity in an irradiation period of irradiated light to adjust a gloss level when photo-curing resin is cured.

By controlling a curing mode of photo-curing resin, a gloss level when photo-curing resin is cured can be adjusted. As a result, the gloss level of cured photo-curing resin can be adjusted according to user's preference.

The present invention also offers a method of curing photo-curing resin applied to a nail, using the above resin curing device. The light quantity in the irradiation period is changed to adjust a gloss level when photo-curing resin is cured.

This method enables to adjust a gloss level when photo-curing resin is cured by controlling a curing mode of photo-curing resin. As a result, the gloss level of the cured photo-curing resin can be adjusted according to user's preference.

### BRIEF DESCRIPTION OF DRAWINGS

FIG. 1 is a sectional view of a resin curing device in accordance with an exemplary embodiment of the present invention.

FIG. 2 illustrates a method of changing a light quantity of the resin curing device in the exemplary embodiment.

FIG. 3A is an example of irradiation pattern of the resin curing device in the exemplary embodiment.

FIG. 3B is an example of irradiation pattern of the resin curing device in the exemplary embodiment.

FIG. 3C is an example of irradiation pattern of the resin curing device in the exemplary embodiment.

FIG. 3D is an example of irradiation pattern of the resin curing device in the exemplary embodiment.

FIG. 4 is a chart showing measuring results of Example 1 of the resin curing device in the exemplary embodiment.

FIG. 5 is a chart showing measuring results of Example 1 of the resin curing device in the exemplary embodiment.

FIG. 6 is a chart showing measuring results of Example 2 of the resin curing device in the exemplary embodiment.

FIG. 7 is a chart showing measuring results of Example 3 of the resin curing device in the exemplary embodiment.

### DESCRIPTION OF EMBODIMENTS

A resin curing device in an exemplary embodiment of the present invention is described below with reference to drawings. The exemplary embodiment described herein is illustrative and not restrictive, and the present invention is in no way limited to this embodiment

### Exemplary Embodiment

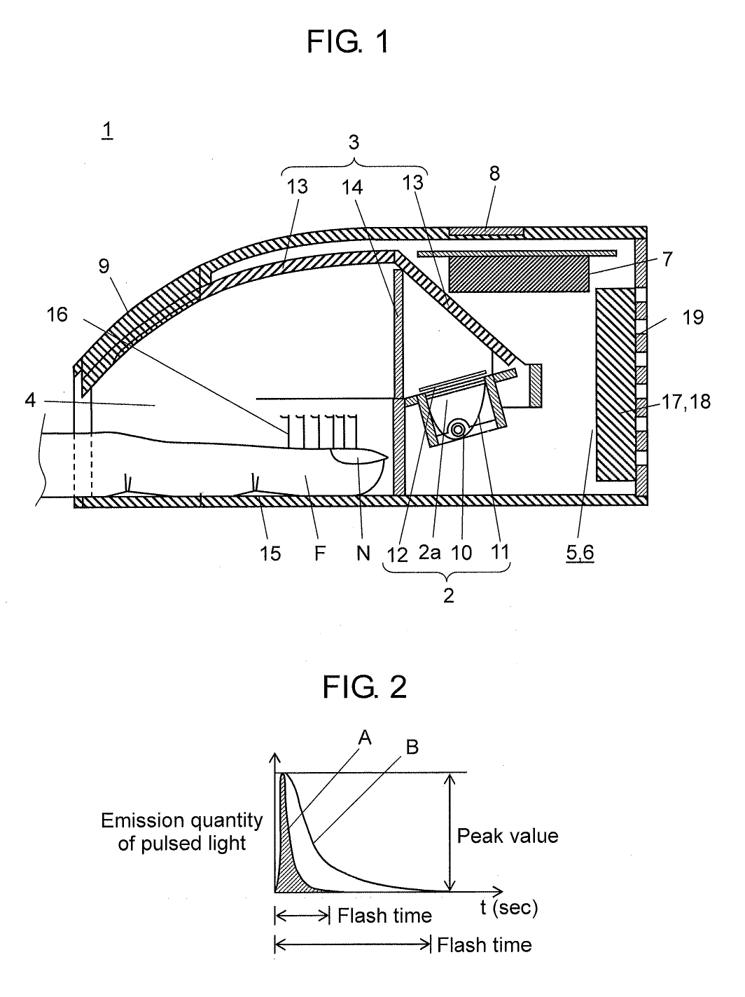

The resin curing device in the exemplary embodiment of the present invention is described below with reference to FIG. 1.

As shown in FIG. 1, resin curing device 1 in this exemplary embodiment at least includes light emitter 2, optical system 3, irradiation chamber 4, dryer 5, cooler 6, controller 7, and operating part 8. They are housed in casing 9. Light emitter 2 emits irradiated light for curing photo-curing resin (not illustrated), such as gel, applied to nail N. Optical system 3 guides the irradiated light to nail N where photo-curing resin is applied. Fingertip F is inserted and housed in irradiation chamber 4 to expose finger N to the irradiated light. Dryer 5 dries photo-curing resin applied to nail N. Cooler 6 cools down light emitter 2. Controller 7 controls light irradiation to photo-curing resin. Action for operating controller 7 is input to operating part 8.

Light emitter 2 at least includes flash lamp 10 configuring a light source, reflector 11, and light selector 12. Flash lamp 10 emits a pulsed light that irradiates an irradiated light at least in a wavelength range including each wavelength for curing multiple types of photo-curing resin. This enables to cure multiple types of photo-curing resin with different irradiated light wavelengths by light emission from one flash lamp 10. Reflector 11 reflects the irradiated light emitted from flash lamp 10 toward light selector 12. Light selector 12 selectively transmits light in a specific range in the irradiated light emitted from flash lamp 10.

Flash lamp 10 configuring light emitter 2 is, for example, a xenon discharge tube, and emits light in broad wavelengths from ultraviolet ray to infrared ray.

Ultraviolet rays are divided into three ranges based on their wavelengths. The first range is an ultraviolet range from not less than 320 nm (or 315 nm) to not more than 400 nm (UV-A: UV in range A). The second range is an ultraviolet range from not less than 280 nm to less than 320 nm (or 315 nm) (UV-B: UV in range B). The third range is an ultraviolet range from not less than 100 nm to less than 280 nm (UV-C: UV in range C). Ultraviolet rays with shorter wavelengths have stronger damage to human body. Therefore, the use of ultraviolet rays in range A, UV-A, is more preferable to the use of ultraviolet rays in range B, UV-B, or ultraviolet rays in range C, UV-C; when the human body is irradiated with ultraviolet ray.

Accordingly, flash lamp 10 in the exemplary embodiment emits irradiated light including ultraviolet rays in range A, UV-A, and ultraviolet rays in range B, UV-B, in the above three ultraviolet ranges.

Resin curing device 1 in the exemplary embodiment emits light from flash lamp 10 multiple times. More specifically, flash lamp 10 emits light at least twice to cure photo-curing resin.

Flash lamp 10 preferably emits light 100 times or less per second. This can prevent excessive load on flash lamp 10. As a result, flash lamp 10 lasts long and keeps high reliability. This is confirmed when flash lamp 10 emits light in a range that its total irradiation energy in wavelength range of irradiated light is between 0.1 J/cm² and 5.0 J/cm².

As shown in FIG. 1, reflector 11 of light emitter 2 is formed in a semi-cylindrical shape along the longer direction, relative to a direction perpendicular to the sheet of FIG. 1, of long flash lamp 10. Light emitted from flash lamp 10 is reflected on an inner peripheral face of reflector 11. In other words, reflector 11 includes flash lamp 10 inside, and is disposed such that light is irradiated from opening 2a opened along the longer direction.

Light selector 12 includes an UV-B cut filter for blocking UV-B light, and an infrared cut filter for blocking light in the infrared range. Light selector 12 covers opening 2a of reflector 11. Accordingly, light selector 12 blocks light in the infrared range and UV-B in the light emitted from flash lamp 10, and selectively transmits light in UV-A and part of visible light range.

The lower limit of wavelength range of light that light selector 12 permits to transmit is not less than 320 nm, preferably not less than 340 nm, and further preferably not less than 360 nm. The upper limit of wavelength range of light that light selector 12 permits to transmit is not greater than 450 nm, preferably not greater than 430 nm, and more preferably not greater than 410 nm.

Therefore, if the lower limit of wavelength range that light selector 12 transmits is set to not less than 360 nm, both peak wavelength 370 nm of UV lamp and peak wavelength 405 nm of LED lamp can be covered. If the upper limit of wavelength range that light selector 12 transmits is set to not greater than 410 nm, both peak wavelength of 370 nm of UV lamp and peak wavelength of 405 nm of LED lamp can be covered. Accordingly, the irradiated light from flash lamp 10 can reliably cure different types of photo-curing resin used for gels in a short time.

Optical system 3 at least includes reflector 13 and light-transmissive protective panel 14. Reflector 13 reflects the irradiated light from light emitter 2 toward a target to be irradiated. Protective panel 14 transmits the light reflected on reflector 13.

Irradiation chamber 4 includes a space that fingertip F with nail N to which photo-curing resin is applied can be inserted. Irradiation chamber 4 includes fingertip table 15 for placing fingertip F at a position where fingertip F can be exposed to the light emitted from light emitter 2.

Dryer 5 includes a plurality of outlets 16 for feeding air into irradiation chamber 4 and air blower 17 for feeding air into irradiation chamber 4 via outlets 16. Dryer 5 typically feeds air to nail N, using air blower 17, through outlets 16 provided on irradiation chamber 4. Accordingly, photo-curing resin applied to nail N is dried.

Cooler 6 includes cooling fan 18 for cooling flash lamp 10. Cooling fan 18 in this exemplary embodiment is commonly used as air blower 17 of dryer 5. Cooling fan 18 takes in air from outside casing 9, and feeds it to inside casing 9 where flash lamp 10 is provided. Air after cooling flash lamp 10 is discharged through outlets 16 into irradiation chamber 4.

Operating part 8 at least includes, although not illustrated, a power switch, irradiation mode selector switch, start switch, and display. The power switch controls ON and OFF of power supply to resin curing device 1. The irradiation mode selector switch is used for selecting an irradiation mode controlled by controller 7. The start switch is input to start irradiation of light from flash lamp 10 in light emitter 2. The display displays a range of pieces of information, including the irradiation mode.

Controller 7 of resin curing device 1 in the exemplary embodiment changes the light quantity in a predetermined irradiation period by controlling light emission of flash lamp 10 for curing photo-curing resin. This adjusts a gloss level of photo-curing resin when it is cured.

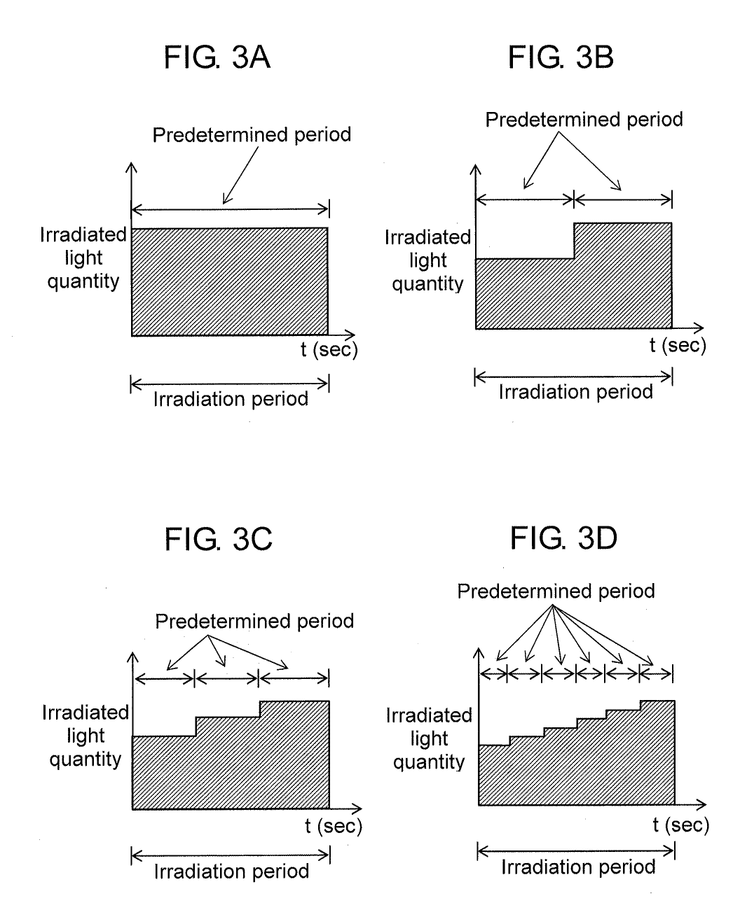

Next is described a method of changing the light quantity in a predetermined irradiation period and a method of adjusting a gloss level, with reference to FIG. 2 and FIGS. 3A to 3D.

FIG. 2 illustrates a method of controlling irradiation energy (light quantity) of the flash lamp in the resin curing device in the exemplary embodiment. FIGS. 3A to 3D are examples of irradiation patterns of the resin curing device in the exemplary embodiment.

First, the method of changing the light quantity with respect to a predetermined irradiation period and the method of adjusting a gloss level are described.

As shown in FIG. 2, controller 7 first controls irradiation energy (light quantity) of flash lamp 10 for curing photo-curing resin.

More specifically, controller 7 controls a flash time of pulsed light emitted from flash lamp 10, such as flash time A and flash time B. This changes irradiation energy (light quantity) of pulsed light of flash lamp 10. In other words, the light quantity of pulsed light is changed just by changing light emission time (flash time), without changing a light emission interval (emission frequency). For example, in case of the emission interval of 66 Hz, 0.1 ms of emission and 15.2 ms of break continue if the light emission time (flash time) is 100 μs.

Light emitter 2 of resin curing device 1 emits irradiated light to photo-curing resin in irradiation patterns shown in FIGS. 3A to 3D. FIG. 3A shows an example that the light is emitted in a fixed emission time (flash time) over the entire irradiation period and the light quantity is fixed. FIG. 3B shows an example that the irradiation period is divided into two predetermined periods, and the emission time (flash time) is extended in each predetermined period to increase the light quantity. In the same way, FIGS. 3C and 3D show examples that the predetermined period is one third (three-division) or one sixth (six-division) of the irradiation period, and the emission time (flash time) is extended in each predetermined period to increase the light quantity.

More specifically, the irradiation period is divided into a plurality of sections, typically shown in FIGS. 3A to 3D, and the emission time (flash time) is changed, such as 90 μs, 100 μs, and 110 μs; in each divided irradiation section (“predetermined period” in the present invention). This changes irradiation energy (light quantity) in each irradiation section, resulting in changing the quantity of light irradiated from light emitter 2 of resin curing device 1 to photo-curing resin. In this case, if an emission interval includes a sufficiently-long break time relative to the emission time (flash time), the light emission interval does not change even if the length of emission time significantly changes.

Controller 7 has irradiation modes for appropriate irradiation of light based on the type and thickness of photo-curing resin. The irradiation modes further include a gloss level selection mode for selecting the gloss level when photo-curing resin is cured.

The gloss level selection mode sets the light quantity in the irradiation period that corresponds to an intended gloss level. The gloss level selection mode includes a standard gloss mode for setting gloss to a standard level, a high gloss mode for setting a higher gloss level (than the standard level), and a low gloss mode for setting a lower gloss level (than the standard level). The above standard gloss level is substantially equivalent (including equivalent) to a gloss level when photo-curing resin is cured with fixed light quantity in the irradiation period using the UV lamp or UV-LED of general resin curing devices.

As described above, controller 7 changes the irradiated light quantity in the predetermined irradiation period in line with the gloss level selection mode set by the irradiation mode, and photo-curing resin is cured by being exposed to this light.

Next, the method of adjusting the gloss level on curing photo-curing resin is detailed.

First, to cure photo-curing resin with low gloss level, controller 7 sets a change of light quantity in the irradiation period close to a fixed value with zero change rate or fixed value (e.g., see FIG. 3A), and light with this light quantity is irradiated.

On the other hand, to cure photo-curing resin with high gloss level, controller 7 sets a large change of light quantity in the irradiation period, and light with this light quantity is irradiated. More specifically, controller 7 divides the irradiation period to two or more predetermined periods (see FIG. 3B or 3C) to change the light quantity stepwise, and photo-curing resin is irradiated with this light. Preferably, controller 7 divides the irradiation period into six predetermined periods (see FIG. 3D) or more to change the light quantity in six or more steps, and photo-curing resin is irradiated with this light. In subsequent description, when the irradiation period is divided into six, the first predetermined period is called “first irradiation section”, and predetermined sections following the first irradiation section to the last section are called “second irradiation section,” “third irradiation section,” “fourth irradiation section, “fifth irradiation section,” and “sixth irradiation section” in the order of elapse of irradiation time. This is same also for other irradiation modes.

In the exemplary embodiment, when the low gloss mode is selected in the gloss level selection modes, controller 7 controls the light quantity by dividing the irradiation period into a fewer sections than that in the high gloss mode (including the case of one irradiation period equivalent to FIG. 3A). In other words, controller 7 controls flash lamp 10 to gain a predetermined light quantity by repeatedly emitting the pulsed light in each predetermined period of the irradiation period.

When the standard gloss mode to the high gloss mode is selected in the gloss level selection modes, controller 7 controls flash lamp 10 to increase the light quantity in each predetermined period stepwise in the irradiation period with passage of irradiation time. In other words, the light quantity in each predetermined period increases from the first irradiation section, which is the section of starting irradiation, toward closer to the end of (or later) irradiation from the second irradiation section to sixth irradiation section in the irradiation period.

The above describes the examples of increasing the quantity of light applied to photo-curing resin when the length of each predetermined period is same. However, the present invention is not limited to this. For example, the light quantity may be fixed, and the irradiation time in each predetermined period in irradiation period may be set longer toward a predetermined period close to the end of irradiation in the irradiation period. This can achieve the same effect, and also increases the reliability by reducing the maximum load of the flash lamp.

Resin curing device 1 in the exemplary embodiment is configured as above.

Next, the operation of resin curing device 1 in the exemplary embodiment is described with reference to FIG. 1.

First, photo-curing resin (gel) is applied to the nail. This gel contains, for example, monomer, oligomer, photopolymerization initiator, and pigment. The power supply of resin curing device 1 is turned on, using operating part 8, and the irradiation mode is also selected.

Next, after selecting the irradiation mode, fingertip F is inserted in irradiation chamber 4, and placed on fingertip table 15. This places nail N at a position on fingertip table 15 where light is irradiated.

Next, by pressing a start switch (not illustrated) of operating part 8, irradiation of light starts. Then, controller 7 starts light irradiation in an intended irradiation pattern according to the irradiation mode set via operating part 8.

When the irradiated light passes through light selector 12 of light emitter 2, UV-B and light in infrared range are blocked. Accordingly, UV-A containing intended wavelength range and light in visible light range pass through light selector 12 of light emitter 2. The transmitted irradiated light further passes through protective panel 14. The irradiated light passing through protective panel 14 is irradiated in irradiation chamber 4 toward fingertip F and nail N in irradiation chamber 4.

Then, photo-curing resin applied to nail N is exposed to the irradiated light whose light quantity increases stepwise with passage of the irradiation period. Accordingly, photo-curing resin applied to nail N is cured.

The method of adjusting a gloss level of photo-curing resin is described below with reference to an example shown FIG. 3D that divides the irradiation period into six predetermined periods from the first irradiation section to sixth irradiation section. This is equivalent to the case of setting the high gloss mode in the gloss level selection modes of the irradiation mode.

First, in the first irradiation section, the irradiated light with predetermined light quantity enters from the surface of photo-curing resin in the thickness direction (from the nail surface side) of photo-curing resin. Here, since the light quantity is relatively small, photopolymerization and curing of photo-curing resin on the surface side is slow. Therefore, the irradiated light is fully transmitted into a deep part of photo-curing resin. As a result, curing of photo-curing resin at the deep part, in addition to the surface, starts. In other words, curing progresses at the deep part of the photo-curing resin in the first irradiation section.

Next, in the second irradiation section, controller 7 increases the light quantity of irradiated light, compared to that in the first irradiation section, and the photo-curing resin is exposed to this light. This encourages photopolymerization of photo-curing resin on the surface more than at the deep part, and curing progresses. As a result, optical transmission of irradiated light to the deep part reduces in line with curing of photo-curing resin on the surface. In other words, curing progresses on the surface of photo-curing resin in the second irradiation section.

Furthermore, controller 7 increases the light quantity of irradiated light stepwise from the third irradiation section to the sixth irradiation section, and continues to expose the photo-curing resin to this light. This selectively cures the photo-curing resin at the deep part in a predetermined period whose irradiation time is closer to the starting of irradiation (e.g., the first irradiation section and the predetermined period close to the first irradiation section timewise). In a predetermined period whose irradiation time is close to the end of irradiation (e.g., the sixth irradiation section and the predetermined period close to the sixth irradiation section timewise), the photo-curing resin is selectively cured on the surface. This enables to cure the photo-curing resin uniformly in the thickness direction and also with firm hardness. As a result, the surface of photo-curing resin (cured face) becomes smooth, and the photo-curing resin can be cured at high gloss level.

Next is described when the standard gloss mode or low gloss mode is set in the gloss level selection modes in the irradiation mode.

In this case, controller 7 controls irradiation to photo-curing resin by dividing the irradiation period into fewer sections, as shown in FIGS. 3A to 3C, than that in the high gloss mode. In this case, hardness at the deep part of photo-curing resin is lower than the high gloss mode, and only hardness on the surface is high. Accordingly, the photo-curing resin is non-uniformly cured in the thickness direction, compared to the high gloss mode. As a result, the surface of photo-curing resin (cured face) becomes rough, and the gloss level of photo-curing resin becomes low.

In other words, resin curing device 1 in the exemplary embodiment can easily adjust the gloss level when photo-curing resin is cured, according to user's preference, by switching the gloss level selection mode to increase the light quantity stepwise and emitting it to photo-curing resin.

### Example 1

The resin curing device in the exemplary embodiment is described in details based on Example 1.

Using resin curing device 1 in the exemplary embodiment, a commercially-sold product of photo-curing resin is cured in the irradiation patterns shown in FIGS. 3A to 3D. Results of measured gloss levels of the photo-curing resin are described with reference to FIGS. 3A to 5.

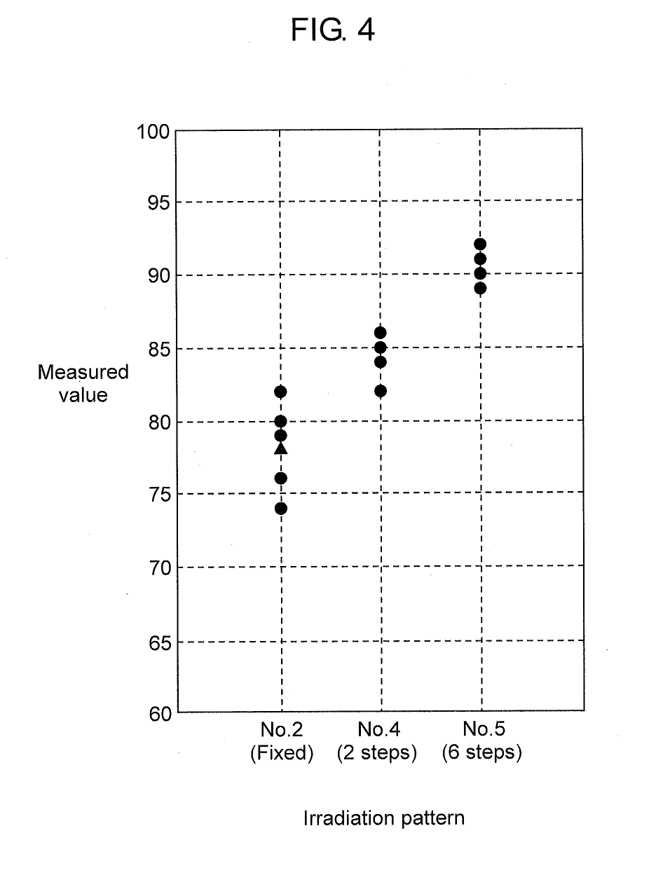

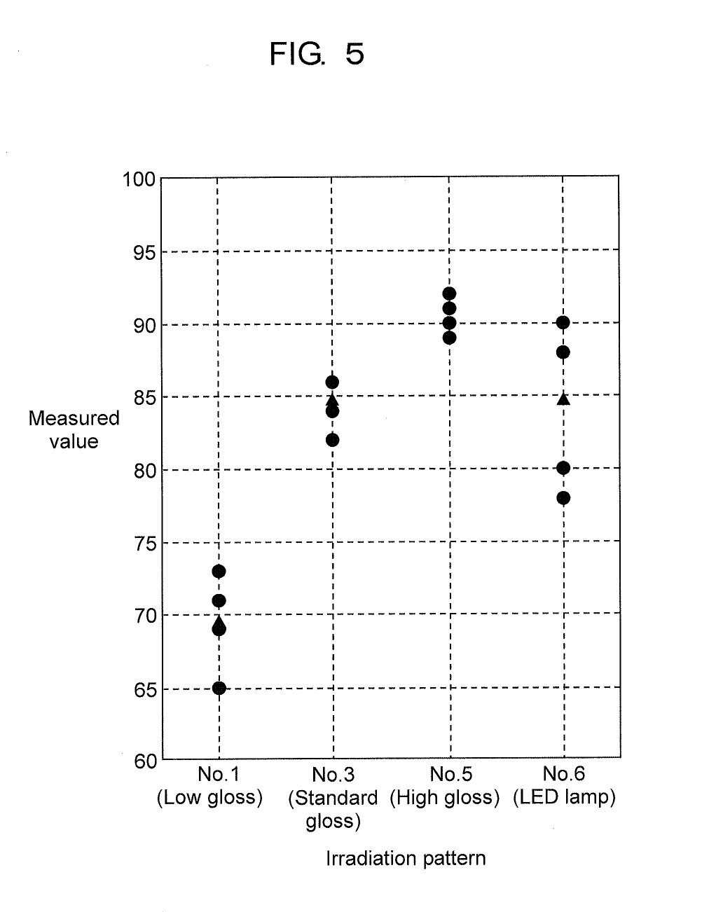

FIGS. 4 and 5 show measurement results of Example 1 of the resin curing device in the exemplary embodiment.

First, the method of measuring gloss level is described.

Color gel made of photo-curing resin is applied to an acrylic board painted black with the size 25 mm×25 mm, using a 50-μm thick shim.

Then, the color gel applied to the acrylic board is exposed to light of flash lamp 10 in each irradiation pattern shown in FIGS. 3A to 3D. Using a 100-μm thick shim, clear gel made of photo-curing resin is then applied over the color gel.

Next, in the same way, the gel is cured by being exposed to light of flash lamp 10 in each irradiation pattern. Then, uncured gel is wiped off with a solvent containing alcohol to prepare a test piece.

A gloss level of each piece of photo-curing resin is measured using a gloss checker, a gloss-meter, by Horiba Seisakusyo (Type: IG-331).

As a measuring condition, the test piece is measured at measuring angle 60°. The color gel and clear gel used is red Presto (trademark) exclusively for LED.

As a light source, a xenon discharge tube whose emission interval is fixed to 66 Hz and UV-LED are used. The xenon discharge tube is used as a light source for the following irradiation patterns No. 1 to No. 5, and UV-LED is used as a light source for irradiation pattern No. 6.

Above irradiation patterns No. 1 to No. 6 in Example 1 are detailed below.

First, as shown in FIG. 3A, irradiation patterns No. 1 and No. 2 are patterns that the irradiation time is fixed and the light quantity is fixed in the predetermined irradiation period. In irradiation pattern No. 1, the irradiation condition is 20 sec of irradiation period and 90 μsec of flash time. On the other hand, the irradiation condition in irradiation pattern No. 2 is 16 sec of irradiation period and 100 μsec of flash time.

In irradiation patterns No. 3 and No. 4, the predetermined irradiation period is divided into two steps (two sections) of predetermined periods, as shown in FIG. 3B. The light quantity is increased stepwise in these patterns. In irradiation pattern No. 3, the irradiation period is 22 sec. The first irradiation section is from 0 sec to 10 sec, and the second irradiation section is from 11 sec to 22 sec. The irradiation condition is 80 μsec of flash time in the first irradiation section and 90 μsec of flash time in the second irradiation section. On the other hand, in irradiation pattern No. 4, the irradiation time is 16 sec. The first irradiation section is from 0 sec to 10 sec, and the second irradiation section is from 11 sec to 16 sec. The irradiation condition is 90 μsec of flash time in the first irradiation section, and 120 μsec of flash time in the second irradiation section.

In irradiation pattern No. 5, the predetermined irradiation period is divided into six steps (six sections) of predetermined periods, as shown in FIG. 3D. The irradiated light quantity increases stepwise in this pattern. In irradiation pattern No. 5, the irradiation time is 18 sec, and is evenly divided into six irradiation sections, which are 3 sec each. The irradiation condition in irradiation pattern No. 5 is 70 μsec of flash time in the first irradiation section, 80 μsec of flash time in the second irradiation section, 90 μsec of flash time in the third irradiation section, 100 μsec of flash time in the fourth irradiation section, and 110 μsec of flash time in the fifth irradiation section, and 120 μsec of flash time in the sixth irradiation section.

Lastly, in irradiation pattern No. 6 using UV-LED that continuously emits light as a light source, the irradiation period is 30 sec and the irradiated light quantity in the irradiation period is fixed, as shown in FIG. 3A.

The gloss level of photo-curing resin is measured five times each in above irradiation patterns No. 1 to No. 6, using the gloss-meter. Table 1 shows their measuring results and averages.

TABLE 1

| Irradiation pattern | 1st | 2nd | 3rd | 4th | 5th | Average |
|---|---|---|---|---|---|---|
| No. 1 | 69 | 73 | 65 | 69 | 71 | 69.4 |
| No. 2 | 74 | 80 | 76 | 82 | 79 | 78.2 |
| No. 3 | 86 | 86 | 82 | 86 | 84 | 84.8 |
| No. 4 | 85 | 86 | 84 | 84 | 82 | 84.2 |
| No. 5 | 90 | 89 | 92 | 89 | 91 | 90.2 |
| No. 6 | 78 | 80 | 90 | 88 | 88 | 84.8 |

It is apparent from the measuring results in Table 1 and FIG. 4 that the gloss level is the lowest in irradiation pattern No. 2, and the gloss level can be increased toward irradiation pattern No. 4 of two-step irradiation and irradiation pattern No. 5 of six-step irradiation. In other words, the gloss level of photo-curing resin can be adjusted by changing the irradiation pattern.

As shown in the measuring results in Table 1 and FIG. 5, irradiation pattern No. 1 is selected to suppress gloss to a low level on curing photo-curing resin. On the other hand, to increase the gloss level, irradiation pattern No. 5 is selected to cure photo-curing resin. Accordingly, the gloss level of photo-curing resin can be easily adjusted.

For the user expecting the gloss level equivalent to conventional LED lamp (see irradiation pattern No. 6 in FIG. 5), irradiation pattern No. 3 is selected for irradiation of photo-curing resin. This can cure the photo-curing resin with the gloss level of conventional photo-curing resin although the light source is changed.

Next, gloss levels of photo-curing resin in the light emission patterns with the same number of irradiation sections, which are irradiation patterns No. 1 and No. 2 and irradiation patterns No. 3 and 4, are compared, considering the total light emission energy of irradiation pattern No. 1 as 100%. As a result, the total light emission energy is 103% in irradiation pattern No. 2, 100% in No. 3, and 103% in No. 4.

Here, the gloss level of photo-curing resin is higher in irradiation pattern No. 2 than that in irradiation pattern No. 1, and higher in irradiation pattern No. 3 than that in irradiation pattern No. 4. Furthermore, the gloss level of photo-curing resin is higher in irradiation patterns No. 3 and No. 4 than in irradiation patterns No. 1 and No. 2.

Based on the above results, it can be estimated that a reason for higher gloss level in irradiation pattern No. 5 whose total light emission energy is 103% than that in other irradiation patterns is an effect of changing the light quantity stepwise in multiple predetermined periods. The gloss level of photo-curing resin does not increase in proportion to the total light emission energy.

### Example 2

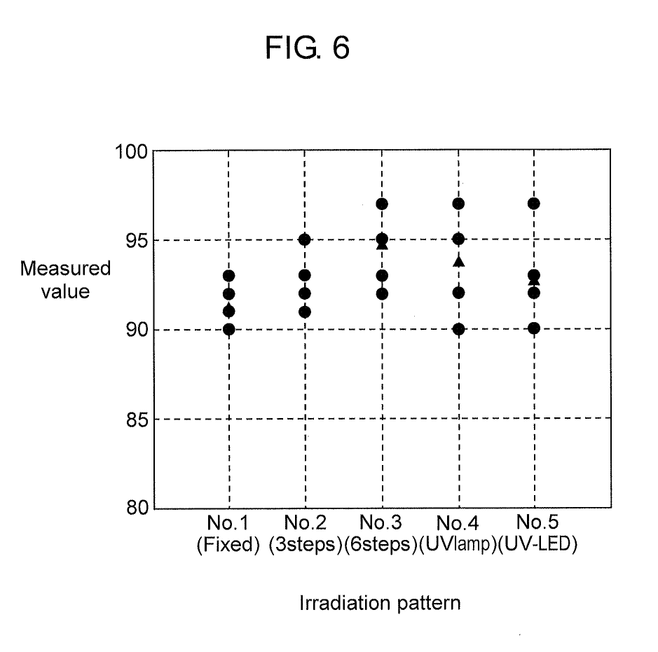

Next are described results of measuring gloss level of photo-curing resin in each irradiation pattern, based on Example 2, in the resin curing device in the exemplary embodiment. The results are detailed with reference to FIGS. 3A to 3D and FIG. 6.

FIG. 6 shows measurement results of Example 2 of the photo-curing device in the exemplary embodiment.

In Example 2, the color gel and clear gel, which are photo-curing resin, in Example 1 are changed to photo-curing resin of pink 2-way Pregel (trademark) for both UV-LED and lamp, and the gloss level in each irradiation pattern is measured. FIG. 6 shows results of measuring gloss level in Example 2. The same method as Example 1 is used for measuring the gloss level.

As a light source, a xenon discharge tube whose light emission interval is fixed to 66 Hz and UV-LED are used. The xenon discharge tube is used as a light source for the following irradiation patterns No. 1 to No. 3. UV-lamp is used as a light source for irradiation pattern No. 4, and UV-LED is used as a light source for irradiation pattern No. 5.

Above irradiation pattern No. 1 to irradiation pattern No. 5 in Example 2 are detailed below.

First, as shown in FIG. 3A, irradiation pattern No. 1 is a pattern that the flash time is fixed and the light quantity is fixed in the predetermined irradiation period. Same as irradiation pattern No. 1 in Example 1, the irradiation period is 20 sec and flash time is 90 μsec in irradiation pattern No. 1.

Next, as shown in FIG. 3C, irradiation pattern No. 2 is a pattern that the predetermined irradiation period is divided in to 3 steps (3 sections) of predetermined periods and the irradiated light quantity is increased stepwise.

Next, as shown in FIG. 3D, irradiation pattern No. 3 is a pattern that the predetermined irradiation period is divided into 6 steps (6 sections) of predetermined periods, same as irradiation pattern No. 5 in Example 1, and the irradiated light quantity is increased stepwise in these periods.

Next, irradiation pattern No. 4 using an UV lamp as a light source is a pattern that the irradiation period is 2 minutes and the irradiated light quantity is fixed, as shown in FIG. 3A.

Lastly, irradiation pattern No. 5 using UV-LED as a light source is a pattern, as shown in FIG. 3A, that the irradiation period is 30 sec and the irradiated light quantity is fixed, same as irradiation pattern No. 6 in Example 1.

Using the gloss-meter, the gloss level of photo-curing resin is measured five times each in above irradiation patterns No. 1 to No. 5.

Table 2 shows their measurement results and averages.

TABLE 2

| Irradiation pattern | 1st | 2nd | 3rd | 4th | 5th | Average |
|---|---|---|---|---|---|---|
| No. 1 | 92 | 90 | 90 | 91 | 93 | 91.2 |
| No. 2 | 92 | 93 | 95 | 95 | 91 | 93.2 |
| No. 3 | 97 | 92 | 95 | 93 | 97 | 94.8 |
| No. 4 | 95 | 97 | 90 | 92 | 95 | 93.8 |
| No. 5 | 90 | 92 | 97 | 93 | 92 | 92.8 |

Measurement results in Table 2 and FIG. 6 reveal that the gloss level of photo-curing resin is the lowest in irradiation pattern No. 1, and the gloss level of photo-curing resin increases toward irradiation pattern No. 2 of three-step irradiation and irradiation pattern No. 3 of six-step irradiation.

In irradiation pattern No. 3 of six-step irradiation, the average gloss level of photo-curing resin can be made higher than that of UV lamp (see irradiation pattern No. 4 in FIG. 6) and UV-LED (see irradiation pattern No. 5 in FIG. 6).

Furthermore, it is apparent that irradiation patterns No. 1 and No. 2 can suppress the gloss level of photo-curing resin more than that of UV lamp and UV-LED.

### Example 3

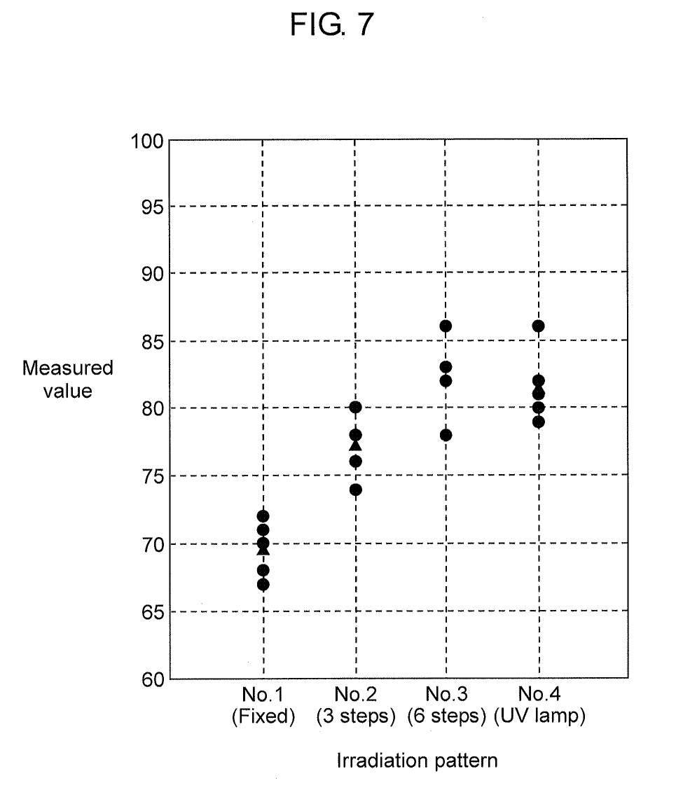

Next are described results of measuring gloss level of photo-curing resin in each irradiation pattern, based on Example 3, in the resin curing device in the exemplary embodiment. The results are detailed with reference to FIGS. 3A to 3D and FIG. 7.

FIG. 7 shows measurement results of Example 3 of the resin curing device in the exemplary embodiment.

In Example 3, color gel and clear gel, which are photo-curing resin, in Example 1 are changed to photo-curing resin of pink Shellac (trademark) exclusively for UV lamp, and the gloss level in each irradiation pattern is measured. FIG. 7 shows measurement results of the gloss level in Example 3. The same method as Example 1 is used for measuring the gloss level.

As a light source, a xenon discharge tube whose emission interval is fixed to 66 Hz and UV lamp are used. The xenon discharge tube is used as a light source in the following irradiation pattern No. 1 to irradiation pattern No. 3, and the UV lamp is used as a light source in irradiation pattern No. 4.

Above irradiation pattern No. 1 to irradiation pattern No. 4 in Example 3 are detailed below.

First, as shown in FIG. 3A, irradiation pattern No. 1 is a pattern that the flash time is fixed and the light quantity is fixed in the predetermined irradiation period. The irradiation condition in irradiation pattern No. 1 is 30 sec of irradiation period and 90 μsec of flash time.

Next, as shown in FIG. 3C, irradiation pattern No. 2 is a pattern that the predetermined irradiation period is divided into 3 steps (3 sections) of predetermined periods, and the light quantity is increased stepwise. The irradiation period is 30 sec, and it is evenly divided into three irradiations sections, which are 10 sec each, from the first irradiation section to third irradiation section in irradiation pattern No. 2. The irradiation condition is 80 μsec of flash time in the first irradiation section, 90 μsec of flash time in the second irradiation section, and 100 μsec of flash time in the third irradiation section.

Next, as shown in FIG. 3D, irradiation pattern No. 3 is a pattern that the predetermined irradiation period is divided into 6 steps (6 sections) of predetermined periods, and the irradiated light quantity is increased stepwise. In irradiation pattern No. 3, the irradiation period is 30 sec, and it is evenly divided into six irradiation sections, which are 5 sec each, from the first irradiation section to sixth irradiation section. In the irradiation condition, the flash time in the first irradiation section is 70 μsec, the flash time in the second irradiation section is 80 μsec, the flash time in the third irradiation section is 90 μsec, the flash time in the fourth irradiation section is 100 μsec, the flash time in the fifth irradiation section is 110 μsec, and the flash time in the sixth irradiation section is 120 μsec.

Lastly, in irradiation pattern No. 4 using UV lamp as a light source, the irradiation period is two minutes and the irradiated light quantity is fixed, as shown in FIG. 3A, same as irradiation pattern No. 4 in Example 2.

Using the gloss-meter, the gloss level of photo-curing resin is measured five times each in above irradiation pattern No. 1 to irradiation pattern No. 4.

Table 3 shows their measurement results and averages.

TABLE 3

| Irradiation pattern | 1st | 2nd | 3rd | 4th | 5th | Average |
|---|---|---|---|---|---|---|
| No. 1 | 68 | 72 | 70 | 71 | 67 | 69.6 |
| No. 2 | 78 | 80 | 74 | 78 | 76 | 77.2 |
| No. 3 | 86 | 82 | 82 | 78 | 83 | 82.2 |
| No. 4 | 80 | 82 | 79 | 86 | 81 | 81.6 |

Measurement results in Table 3 and FIG. 7 reveal that the gloss level of photo-curing resin in irradiation pattern No. 1 is the lowest and the gloss level increases toward irradiation pattern No 2 of three-step irradiation and irradiation pattern No. 3 of six-step irradiation.

An average gloss level of photo-curing resin can be made higher in irradiation pattern No. 3 of six-step irradiation than that using the UV lamp (see irradiation pattern No. 4 in FIG. 7).

Still more, irradiation patterns No. 1 and No. 2 can suppress the gloss level of photo-curing resin lower than that using the UV lamp or UV-LED.

As shown in results in Example 1 to Example 3, it is confirmed that resin curing device 1 in the exemplary embodiment can achieve the same effects in any color gel or clear gel.

Still more, the resin curing device and the method of curing photo-curing resin in the exemplary embodiment are not limited to the above exemplary embodiment. It is apparent that diversifying modifications are applicable within the intention of the present invention.

For example, the above exemplary embodiment refers to the example of exposing fingertip F of hand to irradiated light to decorate nail N of hand. However, the present invention is not limited to hands. For example, the resin curing device may be configured to expose a toenail to light to decorate nails of foot. This achieves the same effect as when providing irradiated light to fingertip F of hand.

Still more, the exemplary embodiment refers to an example of using the xenon discharge tube as a light source. However, the present invention is not limited to this light source. For example, UV lamp, such as a mercury lamp and fluorescent lamp, and ultraviolet ray light-emitting diode (UV-LED) may be used as a light source. In this case, the gloss level when photo-curing resin is cured can be adjusted by changing a change trend of irradiated light quantity in irradiation time, using controller 7, even if the light source is other than the xenon discharge tube.

Still more, the exemplary embodiment refers to the case of changing the irradiated light quantity in the irradiation period by controlling the flash time of pulsed light using controller 7. However the present invention is not limited to this control. For example, controller 7 may control the emission interval or a peak value of pulsed light to change the light quantity. In addition, the light quantity may be changed by combining these controls. Still more, controller 7 may increase or decrease the voltage applied to the xenon discharge tube to increase or decrease the peak value of pulsed light. This changes the irradiated light quantity in the irradiation period. Furthermore, the irradiated light quantity in the irradiation period may be changed by changing the number of light sources to emit light by providing multiple light sources.

In the above description, the resin curing device of the present invention is a resin curing device for curing photo-curing resin applied to the nail, and includes a light source and a controller for controlling irradiation of photo-curing resin. The controller may be configured to adjust the gloss level of photo-curing resin when cured by changing the irradiated light quantity in the irradiation period.

With this configuration, the irradiated light quantity is changed by using difference in curing mode of photo-curing resin applied to the nail by difference in a change of light quantity in the irradiation period. The curing mode of photo-curing resin can be controlled to adjust the gloss level when photo-curing resin is cured. As a result, the gloss level when photo-curing resin is cured can be adjusted, according to user's preference.

Still more, the resin curing device of the present invention uses a flash lamp that emits pulsed light as a light source. The controller preferably changes the irradiated light quantity in the irradiation period of irradiated light by changing the light emission quantity of pulsed light.

This configuration enables the use of a xenon discharge tube that emits pulsed light as a light source. The gloss level when photo-curing resin is cured can be adjusted by changing the light emission quantity of pulsed light of xenon discharge tube.

Still more, in the resin curing device of the present invention, the controller preferably changes the flash time of pulsed light emitted multiple times in the irradiation period in each predetermined period in the irradiation period.

This configuration can change the irradiated light quantity in the irradiation period by changing the flash time in each predetermined period. As a result, the gloss level when photo-curing resin is cured can be adjusted.

Still more, in the resin curing device of the present invention, the controller may divide the irradiation period into six or more predetermined periods and change the irradiated light quantity in each predetermined period to increase the irradiated light quantity with passage of irradiation time.

This configuration can increase the gloss level of photo-curing resin by increasing the irradiated light quantity with passage of irradiation time. In particular, a significant effect can be achieved on the gloss level of photo-curing resin when the irradiation period is divided into six or more sections.

Furthermore, the present invention is the method of curing photo-curing resin applied to a nail using the above resin curing device. The method includes changing an irradiated light quantity in an irradiation period to adjust the gloss level when photo-curing resin is cured.

This method can control the curing mode of photo-curing resin by using a difference in the curing mode of photo-curing resin applied to nail by difference in a change of irradiated light quantity in the irradiation period. By controlling the curing mode of photo-curing resin, the gloss level when photo-curing resin is cured can be adjusted. As a result, the gloss level when photo-curing resin is cured can be adjusted according to user's preference.

### INDUSTRIAL APPLICABILITY

The resin curing device and the method of curing photo-curing resin of the present invention are applicable to purposes in which adjustment of gloss level when photo-curing resin is cured is required.

### REFERENCE MARKS IN THE DRAWINGS

1 Resin-curing device
2 Light emitter
2a Opening
3 Optical system
4 Irradiation chamber
5 Dryer
6 Cooler
7 Controller
8 Operating part
9 Casing
10 Flash lamp (xenon discharge tube)
11 Reflector
12 Light selector
13 Reflector
14 Protective panel
15 Fingertip table
16 Outlet
17 Air blower
18 Cooling fan

1. A resin curing device for curing photo-curing resin applied to a nail by exposing the photo-curing resin to irradiated light, the resin curing device comprising:
a light source; and
a controller for controlling the irradiated light to the photo-curing resin,
wherein
the controller changes an irradiated light quantity in an irradiation period of the irradiated light to adjust a gloss level when the photo-curing resin is cured.

2. The resin curing device of claim 1,
wherein
the light source is a flash lamp that emits a pulsed light, and
the controller changes an emission quantity of the pulsed light to change the irradiated light quantity in the irradiation period of the irradiated light.

3. The resin curing device of claim 2, wherein the controller changes a flash time of the pulsed light in each predetermined period of the irradiation period, the pulsed light being emitted multiple times in the irradiation period.

4. The resin curing device of claim 2, wherein the controller divides the irradiation period of the irradiated light into not less than six predetermined periods, and changes the irradiated light quantity in each of the predetermined periods to increase the irradiated light quantity with passage of irradiation time.

5. A method of curing photo-curing resin applied to a nail, using the resin curing device of claim 1, the method comprising changing an irradiated light quantity in an irradiation period to adjust
a gloss level when the photo-curing resin is cured.

6. The resin curing device of claim 3, wherein the controller divides the irradiation period of the irradiated light into not less than six predetermined periods, and changes the irradiated light quantity in each of the predetermined periods to increase the irradiated light quantity in line with an elapse of irradiation time.
